(19) United States
(12) Patent Application Publication
(10) Pub. No.: US 2006/0280327 A1
(43) Pub. Date: Dec. 14, 2006

(54) Speaker device and acoustic output method thereof as well as image display apparatus

(75) Inventor: Toru Nakagawa, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/444,305

(22) Filed: Jun. 1, 2006

(30) Foreign Application Priority Data
Jun. 9, 2005 (JP) 2005-169706

(51) Int. Cl. H04R 1/02

(52) U.S. Cl. 381/388

(57) ABSTRACT

While the speaker mounting region is improved to look smaller as viewed from the front side, a performance of a speaker device is maintained. The speaker device has a speaker, a first cavity portion formed by extending a front opening of the speaker, a second cavity portion which communicates with the first cavity portion spatially and which has a volume smaller than that of the first cavity portion, and a third cavity portion which communicates with the second cavity portion spatially and which is of a horn shape with a front end side gradually expanded from the second cavity portion side, wherein an acoustic output from the speaker is compressed at the first cavity portion, converted into speed at the second cavity portion, and released from the third cavity portion.

### CROSS-REFERENCE TO RELATED APPLICATIONS

This application is based upon and claims the benefit of priority from Japanese Patent Application No. 2005-169706, filed Jun. 9, 2005, the entire contents of which are incorporated herein by reference.

### BACKGROUND

1. Field

One embodiment of the present invention relates to a speaker device of, for example, a digital TV broadcast receiving apparatus, etc., and an acoustic output method thereof as well as an image display apparatus, and more specifically, to improvement of a configuration of a speaker device, its configuration method, and an image display apparatus having the speaker device along with improvement of an appearance as seen from the front side.

2. Description of the Related Art

In recent years, digital TV broadcasting has been promoted. For example, in Japan, not only satellite digital broadcasting such as broadcasting satellite (BS) digital broadcasting and 110-degree communications satellite (CS) digital broadcasting, but also terrestrial digital broadcasting has been started.

Presently, TV broadcast receiving apparatuses with thin-shaped and large screens, which employ flat panel displays composed of a liquid crystal display, a plasma display, an SED display, or the like as image display units thereof, are likely to gain popularity.

Even in an image display apparatus with a thin-shaped increased-size screen, speakers are essential to obtain audio outputs. Speakers must be mounted to a cabinet with care to prevent acoustic effects from decreasing. To achieve this, the frame at the front side of the cabinet and its design, and a speaker mounting structure are mutually related.

For example, in Jpn. Pat. Appln. KOKAI Publication No. 2003-174692, a thin-shaped image display apparatus is disclosed. In this publication, a speaker mounting structure that can further reduce a wall thickness of right and left of the image display apparatus (the depth size is reduce) is disclosed. Also in Jpn. Pat. Appln. KOKAI Publication No. 2005-24875, a thin-shaped image display apparatus is disclosed. In addition, in Jpn. Pat. Appln. KOKAI Publication No. 08-037692, there is disclosed a structure to guide a sound-emitting unit of a speaker device located at the rear to a frame on the front of a receiver. Furthermore, in Jpn. Pat. Appln. KOKAI Publication Nos. 06-284488 and 08-056319, a structure to guide sound from a speaker located at the rear to the right and left portions of a front frame is disclosed.

In the case of a thin-shaped image display apparatus, a speaker mounting place is also restricted because of its thinned shape. Since there is little clearance on the back face of a display screen, speakers are arranged around the display screen. For example, speakers are arranged at the lower part of the display screen.

In the case of a conventional image display apparatus, a sound emitting unit is installed at the edge of a front frame, and for the sound emitting unit, an area the same as that of a speaker opening is assigned. Consequently, when the edge of the frame is seen, there exist a region of a display screen and a region of the sound emitting unit substantially equal to the speaker opening. Now, in the case where, for example, design is made to reduce the edge width as viewed from the front side of the frame edge around the display screen, it becomes difficult to mount a speaker.

### BRIEF SUMMARY OF THE INVENTION

In consideration of the above circumstances, in one embodiment, contrivance has been made to a frame edge, particularly, a speaker mounting region so as to look smaller as viewed from the front side when viewing a frame portion from the front side.

An object of the embodiment is to provide a speaker device which is made to prevent speaker acoustic effects from being impaired along with improvement that, particularly, the speaker mounting region is made to look smaller as viewed from the front side, and an acoustic output method thereof as well as an image display apparatus having the speaker device.

Another object of the embodiment is to provide a speaker device which is made compact, achieves good assembly operability to a cabinet and has the number of parts reduced, and its configuration method as well as an image display apparatus using the speaker device.

According to one embodiment of the present invention, there is provided an acoustic output method of a speaker device comprising: a speaker 72; a first cavity portion formed by extending a front opening of the speaker; a second cavity portion which communicates with the first cavity portion spatially and which has a volume smaller than that of the first cavity portion; and a third cavity portion which communicates with the second cavity portion spatially and which is of a horn shape with a front end side gradually expanded from the second cavity portion side, wherein an acoustic output from the speaker is compressed at the first cavity portion, converted into speed at the second cavity portion, and released from the third cavity portion.

According to another embodiment of the present invention, there is provided a speaker device comprising: a speaker; a unit substrate to one face of which the circumference of a front opening of the speaker is mounted; a first cavity portion which is formed on the unit substrate and formed by extending the opening of the speaker spatially to the other face side of the unit substrate; an opening portion which communicates with the first cavity portion and which is formed in an area smaller than the opening area of the first cavity portion; a second cavity portion formed protrudably so as to extend the opening to the other face side of the unit substrate; and a third cavity portion in which a reduced rear opening is bonded to a front end opening of the second cavity portion and cross-sectional profiles of first and second faces that continuously extend from the rear opening form the reduced rear opening at a position where they are tentatively retreated while being bent to come close to each other as they are oriented from the extended front opening to the reduced rear opening.

According to still another embodiment of the present invention, there is provided an image display apparatus with an image display unit and a speaker device mounted to a cabinet, comprising: a front frame forming the cabinet, on which a display screen of the image display unit is arranged to be exposed from an opening at the center thereof; a frame forming portion which forms a part of the front frame and is positioned at the lower part of the front frame; a front opening portion formed slenderly in the frame forming portion in the lateral direction; a speaker arranged on the rear side of the opening portion; a first cavity portion formed by extending an opening of the speaker; a second cavity portion which communicates with the first cavity portion and which has a volume smaller than that of the first cavity portion; and a third cavity portion which communicates with the second cavity portion and which has a horn shape in which a front head end side gradually expands from the second cavity portion side and is connected to the front opening portion of the frame forming portion.

### RIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view showing an overview of an image display apparatus which is one embodiment;

FIG. 2 is a view showing a part of FIG. 1 in an enlarged manner;

FIG. 3 is a perspective view showing the back side of a sound emitting unit 21R of FIG. 1;

FIG. 4 is a perspective view showing a speaker device 60R shown in FIG. 3 by taking it out;

FIG. 5 is a perspective view showing the speaker device 60R shown in FIG. 4 as viewed from the front side;

FIG. 6 is a perspective view showing the speaker device 60R shown in FIG. 5 as viewed from the side;

FIG. 7 is a view showing a state in which speaker devices are mounted with the image display apparatus shown in FIG. 1 as viewed from the back side;

FIG. 8 is an illustration showing a mounting state of the speaker device and a frame forming portion in one embodiment;

FIGS. 9A and 9B are illustrations shown to explain functions and effects of the frame forming portion shown in FIG. 8;

FIGS. 10A and 10B are illustrations shown to explain one example of the effects of the apparatus according to the embodiment;

FIGS. 11A to 11C are illustrations shown to explain characteristics of the speaker device according to the embodiment; and

FIG. 12 is an exemplary diagram showing a circuit block of the image display apparatus according to the embodiment.

### DETAILED DESCRIPTION

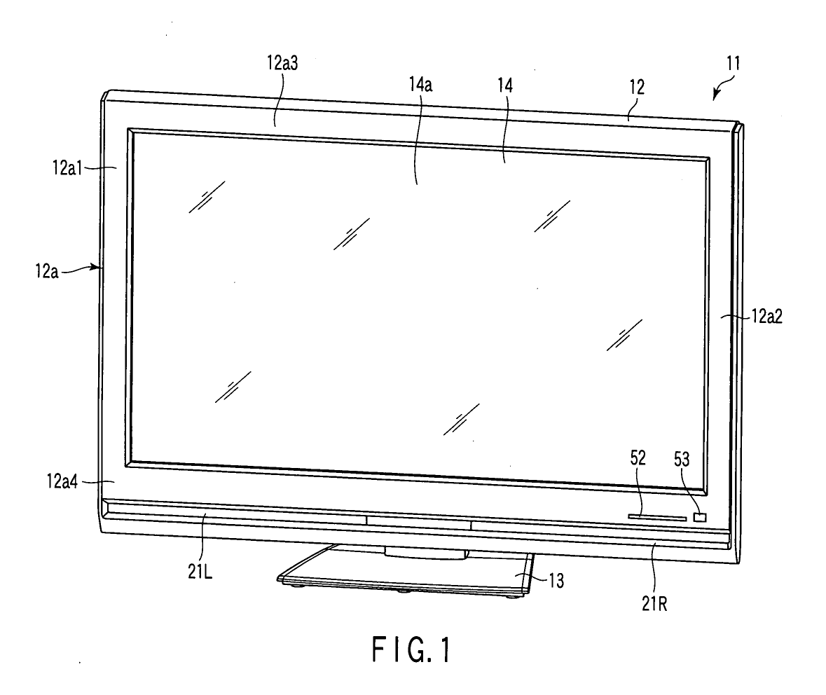

Various embodiments according to the invention will be described hereinafter with reference to the accompanying drawings. In general, according to one embodiment of the invention, FIG. 1 shows the appearance of the front side of a TV broadcast receiving apparatus 11 to be explained in this embodiment. The TV broadcast receiving apparatus 11 is primarily composed of a thin-shaped cabinet 12 formed into a substantially quadrangle, the cabinet serving as an apparatus main body, and a stand 13 which supports the cabinet 12 upright. The stand 13 is formed into a substantially thin-shaped box.

The cabinet 12 has a front frame 12a. The frame 12a is formed by frame forming portions 12a1, 12a2, 12a3 and 12a4 which are arranged right and left and top and bottom to configure the front frame 12a. In this case, the structure of the frame forming portion 12a4 at the lower part has characteristics in particular, which will be explained in detail later.

From an opening of the frame 12a of the cabinet 12, a display screen 14a of an image display unit 14 composed of, for example, a flat type liquid crystal display panel or the like is exposed. Herein, explanation is made with a horizontal scanning line direction designated as right and left and a vertical direction as top and bottom when viewing the screen from the front side.

On the frame forming portion 12a4 located at the lower part of the frame 12, right and left sound emitting units 21L and 21R are formed in a slit form in a lateral direction as viewed from the front side. Furthermore, under this condition, the frame forming portion 12a4 is designed to reduce its width W1 to be as little as possible as viewed from the front. Nets are put up to thee sound emitting units 21L and 21R to prevent dust or the like from coming into the cabinet 12.

Moreover, above the sound emitting unit 21R, a slit-form indicator window 52 and a rectangular remote control signal receiving window 53 are provided in the frame forming portion 12a4.

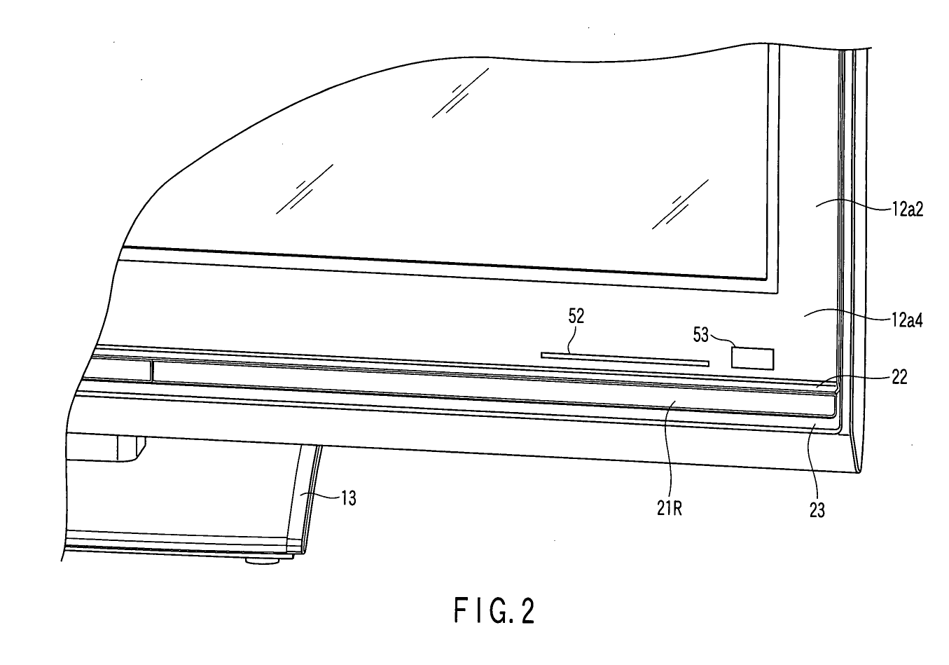

FIG. 2 is an enlarged view of the periphery of the sound emitting unit 21R. Top and bottom walls 22 and 23 which configure the sound emitting unit 21R have an ingenious profile to improve acoustic effects. The walls 22 and 23 are formed into a horn shape in which the walls bend and expand in directions in which they depart from each other as they head from the sound emitting opening to the front as viewed from the cross section. This profile and acoustic effects will be explained further in detail later.

As described above, the sound emitting unit has a feature in that it is formed as a slender opening portion in the lateral direction in the frame forming portion 12a4 and has a shape which forms a rear opening at a position where the upper and lower walls 22 and 23 of the opening portion are tentatively retreated while being bent to come close to each other from the vertical direction as the shape as viewed from the cross section is oriented from a front opening to the rear opening, in order to obtain a horn shape at the opening portion.

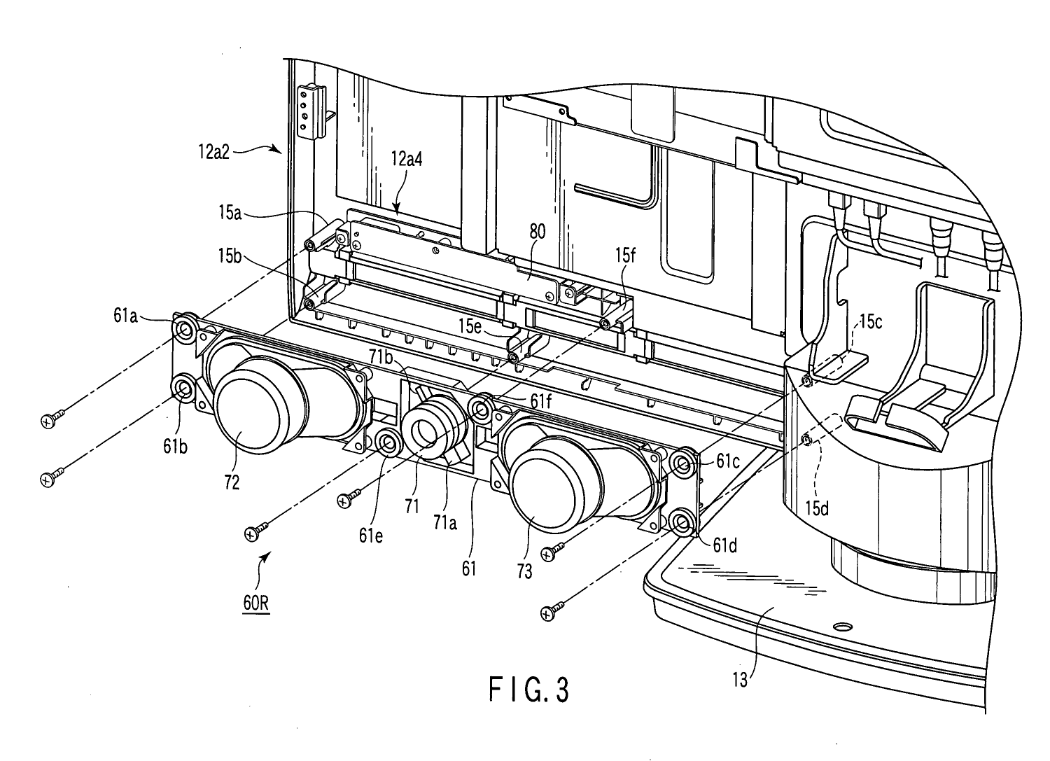

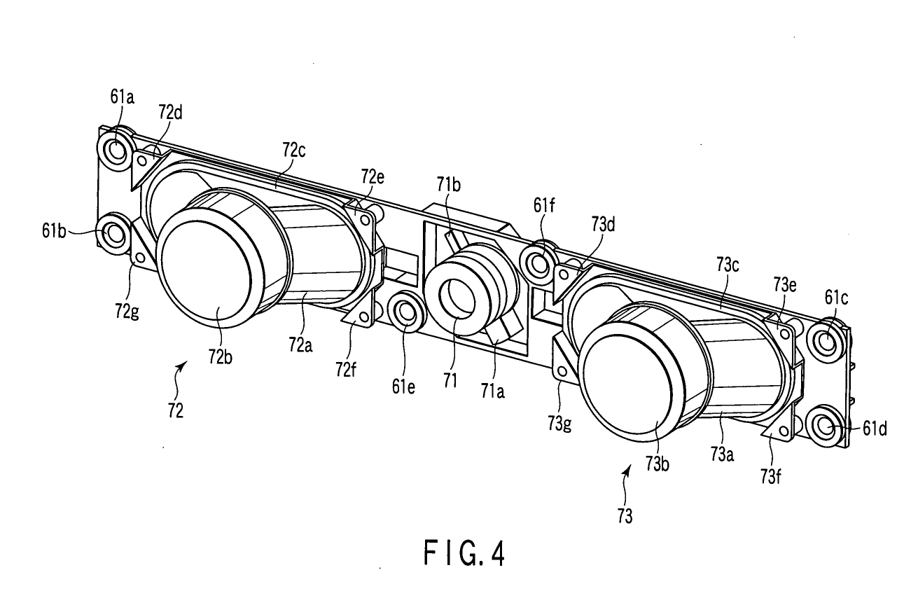

FIG. 3 is a view showing a speaker device 60R mounting portion as viewed from the back side of the cabinet 12 as against FIG. 2 which is the view as viewed from the front. The speaker device 60R is shown in FIG. 4 as well. Speaker devices are mounted to the right and left of the frame forming portion 12a4 of the cabinet, that is, to the back faces of the sound emitting units 21L and 21R of FIG. 1, respectively. Since both have the same configuration, one speaker device 60R will be described with reference to FIGS. 3 and 4.

The speaker device 60R has a rectangular unit substrate 61. The unit substrate 61 has mounting holes 61a, 61b, 61c and 61d at corners on the right and left and top and bottom thereof. The unit substrate 61 also has mounting holes 61e and 61f at positions deviated right and left at the top and bottom of a center region of the unit substrate 61. Elastic rings serving as vibration absorbers are provided on the mounting holes 61a to 61f, respectively. The elastic rings are arranged on the respective holes at one and the other surfaces of the unit substrate 61. The numbers of mounting holes and the vibration absorbers used for the holes are kept as small as possible to achieve cost reduction, decrease in assembly man-hours, and convenience of assembly.

At the center in the horizontal direction and the center in the vertical direction of the unit substrate 61, a high-range speaker (a so-called tweeter) 71 is mounted from the back side of the substrate 61. The high-range speaker 71 is fixed by mounting portions 71a and 71b to the unit substrate 61. The line which connects the mounting portions 71a and 71b crosses at right angles and intersects the line which connects the mounting holes 61e and 61f.

Furthermore, to the unit substrate 61, a low-range speaker 72 is mounted on the left side as viewed from the back side and a low-range speaker 73 is mounted on the right side. The speakers 72 and 73 have metal frames 72a and 73a with an elliptical opening, respectively, and drive portions 72b and 73b are integrated at the rear of the frames 72a and 73a, respectively. In addition, collars 72c and 73c are formed around the anterior openings of the frames 72a and 73a. Mounting pieces are formed at the corners of the collars 72c and 73c, and these mounting pieces are, for example, screwed to mounting protrusions formed upright in the unit substrate 61, respectively. Reference numerals 72d, 72e, 72f and 72g are mounting pieces of the speaker 72, and reference numerals 73d, 73e, 73f and 73g are mounting pieces of the speaker 73.

As shown in FIG. 3, on the rear side of the frame forming portion 12a4 of the frame 12a where the speaker device 60R is located, supporting portions 15a to 15f are formed upright integrally with the cabinet at the positions corresponding to the mounting holes 61a to 61f. In FIG. 3, the supporting portions 15a, 15b, 15e and 15f are viewed while the supporting portions 15c and 15d are hidden.

The speaker device 60R has the mounting holes 61a through 61f aligned to the supporting portions 15a to 15f, and screws are driven, for example, from the mounting holes 61a to 61f towards the supporting portions 15a to 15f. As a consequence, the speaker device 60R is integrated with the cabinet 12a.

In this case, a clearance is generated between the unit substrate 61 of the speaker device 60R and the back face of the frame forming portion 12a4 which forms the frame 12a.

Therefore, in this apparatus, a substrate 80 having indicators and a remote control receiver circuit mounted thereon is attached to the clearance. The remote control receiver circuit mounted on the substrate 80 faces the remote control signal receiving window 53, and the indicators such as LEDs face the indicator window 52. Because the substrate 80 is arranged in the clearance between the unit substrate 61 of the speaker device 60R and the frame forming portion 12a4, there is no need to specially expand the width W1 of the frame forming portion 12a4 in order to arrange the substrate 80. The substrate 80 is fixed to protruded pin-form supporting portions on the rear side of the frame forming portion 12a4 with screws or the like.

FIG. 5 is a view of the speaker device 60R as viewed from the front side. An opening 61g is formed in the unit substrate 61 so as to correspond to the opening portion of the high-range speaker 71. In correspondence to the opening portions of the low-range speakers 72, 73, openings 61h and 61i are formed. Reference numbers 61j and 61k are beams installed to stabilize the width of the opening 61h at the time of manufacturing, and reference numbers 61l and 61m provided to the opening portion 61A are beams installed to stabilize the width of the opening 61i at the time of manufacture.

In the unit substrate 61, a chamber portion 62a which extends the opening of the speaker 72 forward is formed, and in addition, a chamber portion 63a which extends the opening of the speaker 73 forward is formed. In addition, a guide portion 62b which accelerates air vibration by sound pressure inside of the chamber portion 62 and guides it to the horn portion of the frame 12 is formed around the opening 61h, and protrudes anteriorly. Similarly, a guide portion 63b which accelerates air vibration by sound pressure inside of the chamber portion 63 and guides it to the horn portion of the frame 12 is formed around the opening 61i, and protrudes anteriorly.

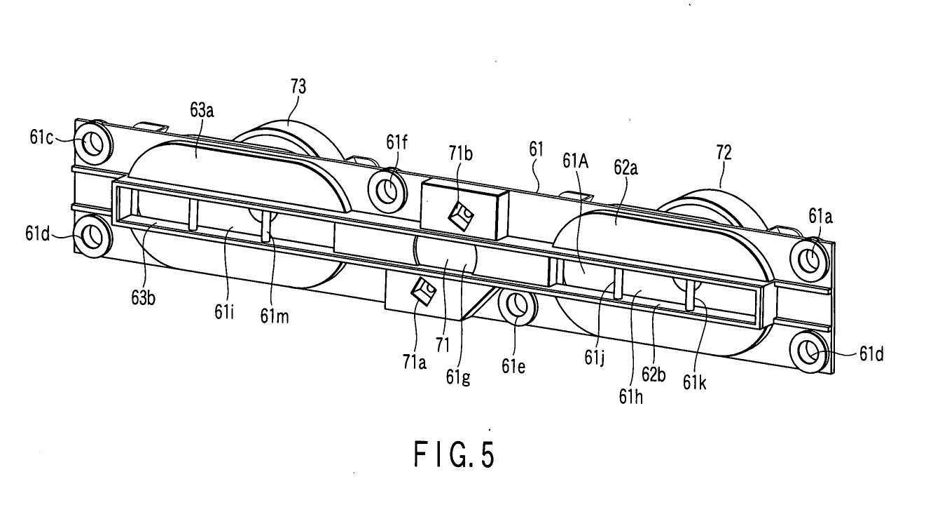

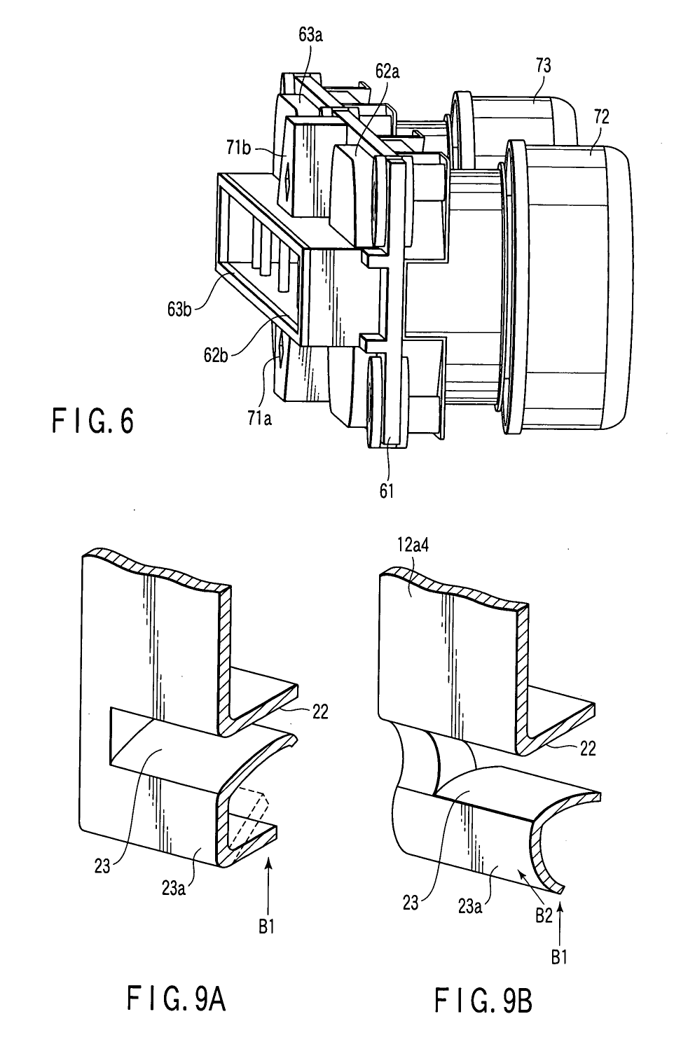

FIG. 6 is a view of the speaker device 60R as viewed from the side. The figure indicates that on the front side of the unit substrate 61, the above-described chamber portions 62a and 63a are protrudedly formed and the guide portions 62b and 63b are also protrudedly formed.

Now, the length of the unit substrate 61 in a short-side direction is, for example, within 110% of the length of the diameter of the speaker in the same direction when the speaker is arranged.

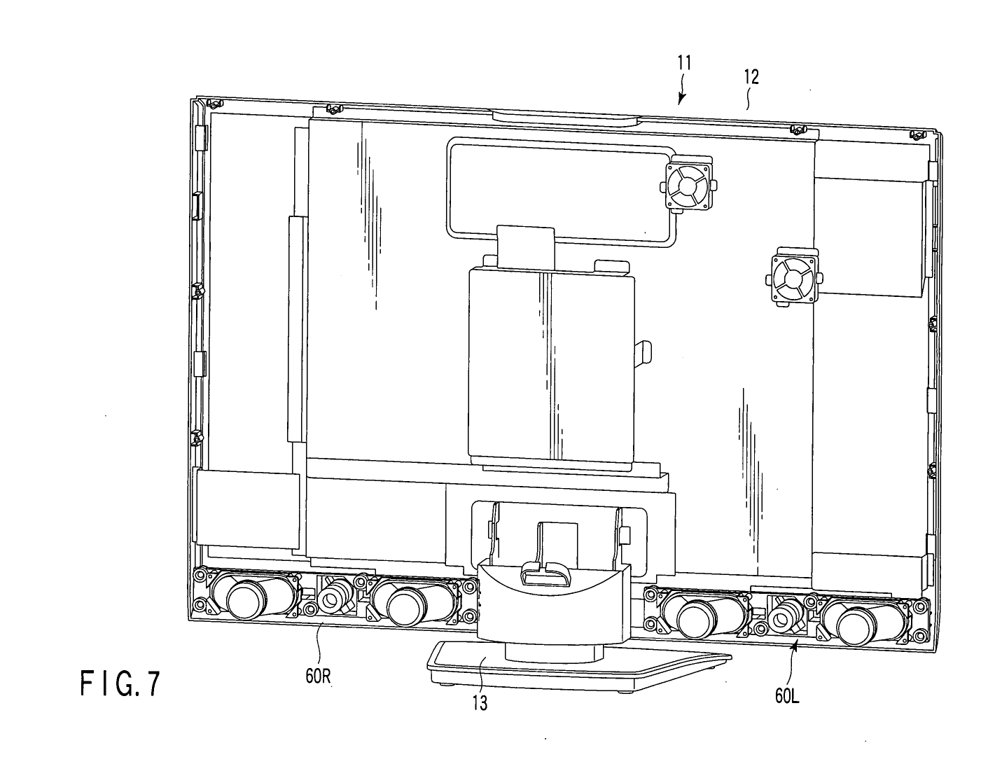

FIG. 7 shows the back side of the above-mentioned cabinet 12. The speaker device 60R is mounted on the rear side of the frame forming portion 12a4 which forms the frame. A speaker device 60L on the left side is mounted as well. The speaker device 60L has the same configuration as that of the speaker device 60R, and a method of mounting to the frame forming portion is the same as the mounting method described above.

The speaker devices 60R and 60L are configured symmetrically with respect to a point with center at a central axis P of the high-range speaker at the center. The mounting holes 61e and 61f are symmetrical with respect to a point, the mounting holes 61a and 61d are also symmetrical with respect to a point, and the mounting holes 61b and 61c are also symmetrical with respect to a point. Furthermore, the speakers 72 and 73 are in the relation symmetrical with respect to a point as well.

This makes assembly work easy. That is, it is possible to mount the speaker device 60R on the speaker device 60L side, and conversely, the speaker device 60L can be mounted to the speaker device 60R side. Further, even when the speaker device is turned upside down, for example, when the speaker device 60R is rotated with center at the central axis and reversed horizontally, the mounting holes and the supporting portions match, so that speakers can be easily mounted. This means that a high degree of freedom can be secured in postures at the time of transporting and receiving speaker devices when speaker devices are assembled in a cabinet on an assembly line. This facilitates production line design, and ensures extremely good efficiency and eliminates errors when assembly workers manually assemble image display apparatuses.

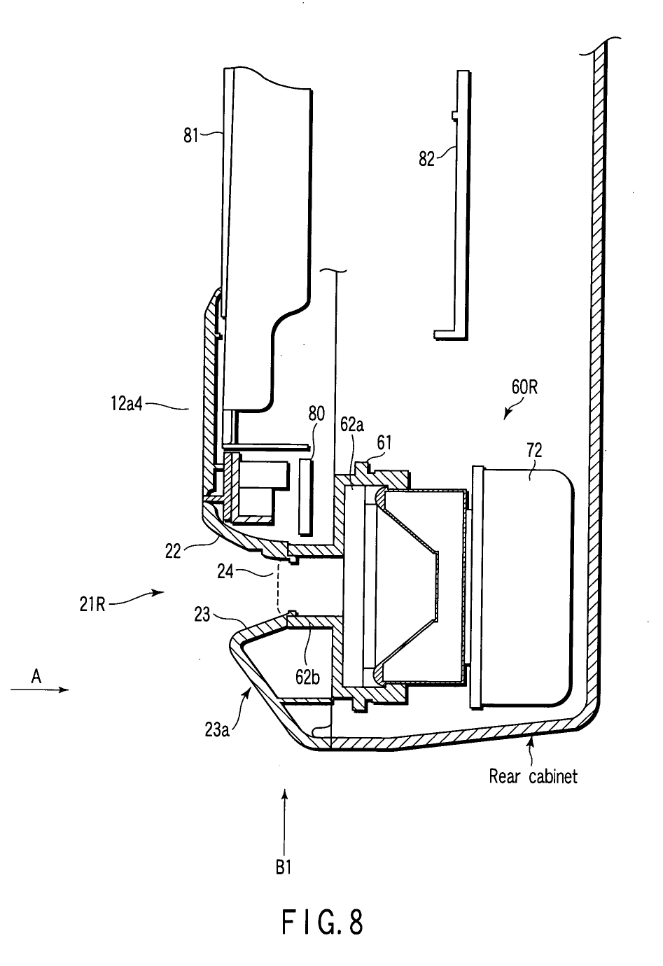

FIG. 8 is a cross-sectional view showing the mounting state of the speaker device 60R and the frame forming portion 12a4 of the cabinet 12. Reference numeral 81 denotes a liquid crystal panel, and reference numeral 82 denotes a chassis plate.

In the sound emitting unit of the frame forming portion 12a4, the shapes of the top and bottom walls 22 and 23 are specially designed to improve acoustic effects, as described above. These walls 22 and 23 have a horn shape which bend and expand in such a manner as to depart away from each other in the top and bottom directions as they are oriented from the sound emitting opening to the front as viewed from the cross section. A net 24 is put up to the opening configured by the walls 22 and 23 (opposite surfaces to configure the horn portion) and narrowed in width at the bottom.

Now, the lower wall 23a which continues from the wall 23 has a profile as viewed from the cross section, which bends while returning backwards to the back side as shown in FIG. 8. Because of this kind of profile, the front face of the wall 23a provides a function which makes it less visually noticeable for the viewers located in front of the apparatus. This is because, as compared to a wall which looks vertical as viewed from the front side and opposes to the audience, the wall 23a tilts and faces the viewers while looking downward as viewed from the front side (as viewed in the arrow A direction) and reflection of light from this surface is not headed for the viewers but is directed downwards. Consequently, when the frame portion is viewed from the front side, the frame edge, particularly, the speaker mounting region can be made to look smaller as viewed from the front side.

Furthermore, by adopting the above-mentioned profile, the strength of the frame 12a is reinforced when the apparatus is lifted with force applied to the bottom of the frame forming portion 12a4. Assuming that the apparatus has a configuration as shown in FIG. 9A, the force B1 is directly applied to the thickness direction of the frame forming portion, and thus, deformation is likely to occur. On the contrary, as shown in FIG. 9B, the force B1 applied to the lower part of the frame forming portion 12a4 is converted to the B2 direction and exerted to the width direction of the wall 23a. Consequently, the wall 23a is free of deformation, achieving advantage in transportation work.

As described above, in this apparatus, the speaker mounting region at the frame edge is designed to look smaller as viewed from the front side. Consequently, the sound emitting units 21R and 21L are designed to have a slender profile in the lateral direction. However, since this profile is adopted, the speaker opening is unable to be directly mounted to the rear side of the frame forming portion 12a4 in order to maintain or improve acoustic effects. Therefore, in this embodiment, the sound emitting units 21R and 21L are made to have a horn shape, and the speaker devices 60R and 60L are retreated from the back face of the frame forming portion 12a4 and arranged.

As a result, a clearance is generated between the speaker device 60R and the frame forming portion 12a4. Therefore, in this apparatus, the substrate 80 having the above-mentioned indicators and remote control receiver circuit mounted thereon is installed to the clearance in order to effectively utilize this clearance. The substrate 80 is arranged to the clearance between the unit substrate 61 of the speaker device 60R and the frame forming portion 12a4 without increasing the width W1 of the frame forming portion 12a4. The substrate 80 is fixed to protruded pin-form supporting portions on the rear side of the frame forming portion 12a4 with screws or the like.

Furthermore, as seen from FIG. 8, in the sound emitting unit 21R, the front protruded portion of the lower wall 23 is retreated as compared to the front protruded portion of the upper wall 22. Consequently, acoustic outputs provided by the sound emitting unit has a larger ratio of components which advance along the lower walls 23 and 23a as compared to that of the vertically symmetrical horn shape. Then, acoustic components which have advanced to the lower side are reflected by the floor and are transmitted forward. This is particularly effective for high-pitched components.

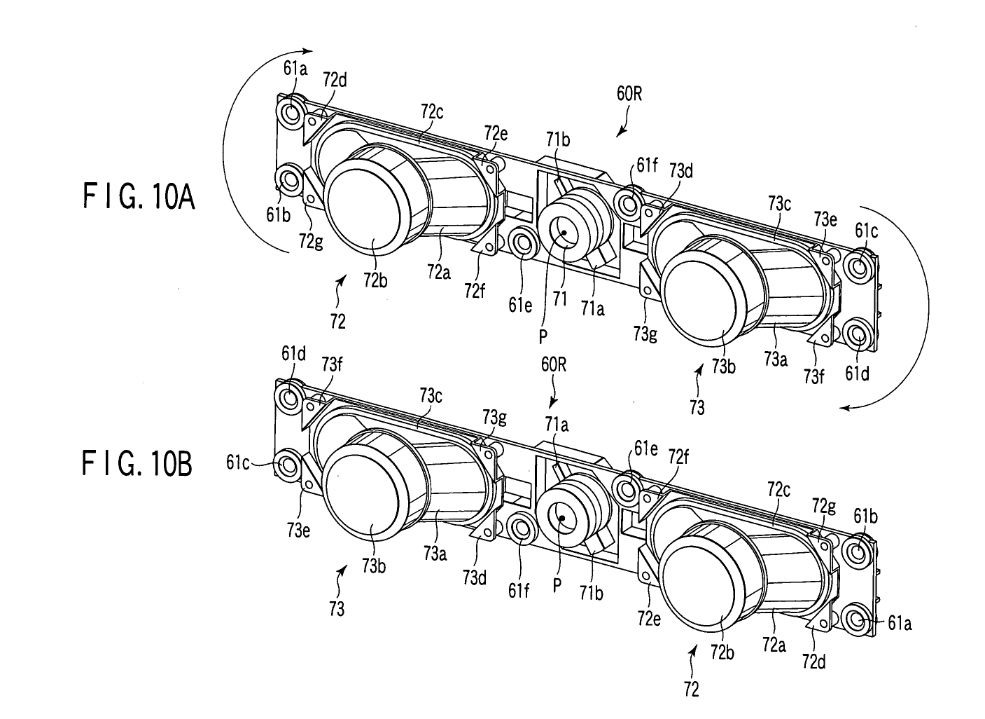

FIG. 10 is shown to explain one example of design effects of the above-mentioned speaker device. The speaker device 60R in a state of FIG. 10A is configured symmetrically with respect to a point with center at a central position P. Consequently, even when the speaker device is rotated around the central position P to be brought to a state as shown in FIG. 10B, mounting holes 61a to 61f correspond to the supporting portions of the cabinet as they are. That is, the state of FIG. 10A and the state of FIG. 10B are equivalent postures. Accordingly, the operability when the speaker device is mounted to the cabinet becomes extremely convenient. A user can arrange speaker devices to predetermined positions without being confused with the direction at the time of mounting the speaker devices. Further, this is true of the relationship between the speaker devices 61R and 61L shown in FIG. 7. For example, the speaker devices 61R and 61L can be fixed to the cabinet without causing any problems even when the speaker devices 61R and 61L are interchanged and arranged. This means that manufacture itself of the speaker devices can be standardized. Furthermore, the line that connects the high-range speaker mounting portions 71a and 71b and the line that connects the mounting holes 61e and 61f are designed to have a relation to intersect at the central position P. By providing these mounting holes 61e and 61f, the speaker device can be fixed by a smaller number of mounting holes. This is effective for operability and for reducing cost.

In addition, providing mounting holes at the top and bottom of the speaker 71 requires the width of the unit substrate to be increased, but adopting the above-mentioned configuration does not need to increase the width of the unit substrate.

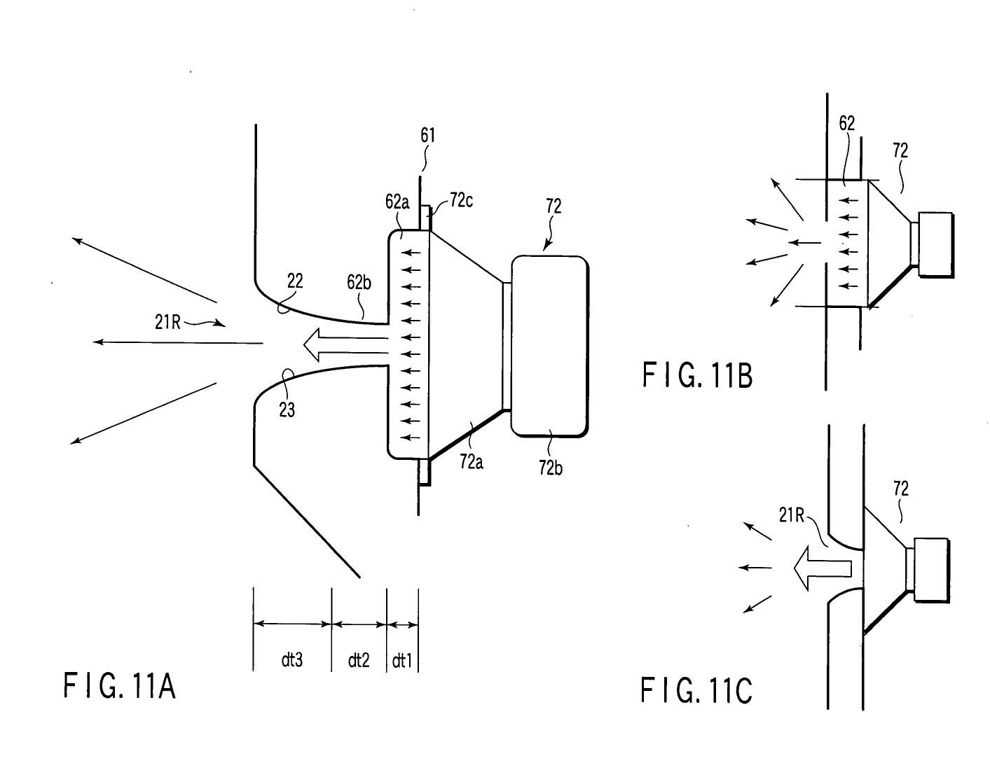

FIG. 11A is shown to explain a characteristic acoustic output method of the speaker device adopted for this embodiment. The speaker devices 60R and 60L have the following characteristics.

First of all, the acoustic output method has the following characteristics. An acoustic output of the speaker 72 is guided to the chamber 62a which extends the speaker opening. Next, the sound in the chamber 62a is guided from the chamber 62a to the guide portion 62b which has a volume smaller than that of the chamber 62a, where the sound is compressed. Here, a sound pressure is converted from volume to speed. Then, the compressed sound is guided from the guide portion 62b to a horn-shaped sound emitting unit 21R and released.

More specifically, an acoustic output of the speaker 71 is stored temporarily at an interval dt1 of the chamber 62a and compressed at a following interval dt2 to be converted into the speed. That is, the pressure is converted at the chamber 62a. This strengthens low-pitched sound components. Because the sound pressure of the strengthened pressure passes a narrow sound guide portion of the interval dt2, a flow rate increases. Then, this flow rate is converted to pressure again. That is, the compressed acoustic output is released at an interval dt3. In this case, since the acoustic output passes the horn-shaped portion, the low-pitched sound pressure efficiently expands with directivity. In addition, since the speaker has the pressure increased at the chamber (cavity portion) 62a and an appropriate load is applied to a vibrating plate, deflection of the vibrating plate which is likely to occur in the case of low-pitched sound reproduction which requires a particularly large stroke can be suppressed. Consequently, the low-pitched sound pressure discharged from the entire vibrating plate is fully used efficiently. In this embodiment, an opening portion of an area about 30% of the area of the speaker opening for the unit substrate has been formed on the bottom of the chamber. It is natural for the chamber to have a depth greater than the width of the vibration amplitude of the vibrating plate.

Further, this embodiment provides a method of configuring an acoustic output unit of a speaker device which outputs an acoustic output of a speaker from the acoustic output unit on the front side, in which the acoustic output from the speaker is stored in the chamber 62a which extends the opening of the speaker 72 spatially forwards. The opening portion 61h at the bottom of the chamber to which the speaker opposes is provided in an area smaller than the bottom, the opening portion is further extended at the guide portion 62b, and the acoustic output stored in the chamber is thereby compressed. The acoustic output compressed at the sound emitting unit 21R which is made into a horn shape by bonding the rear opening to the head opening of the guide portion is released.

The speaker device according to this embodiment has structural characteristics as well. More specifically, the speaker device has: the unit substrate 61, to one face of which a collar portion around the opening of the speaker 72 is mounted; the chamber 62a formed on the unit substrate 61 and formed by spatially extending the speaker opening to the other face side of the unit substrate; and the opening portion 61h formed on the bottom of the chamber so as to be sufficiently smaller than the area of the bottom. The speaker device also has the guide portion 62b formed to extend the opening portion 61h to the other face side of the unit substrate. Furthermore, the speaker device has the sound emitting unit 21R in which a rear part opening is bonded to a front end opening of the guide portion 62b and a rear opening is formed at a position where the profiles of the upper and lower walls 22 and 23 as viewed from the cross section are tentatively retreated while being bent to come close to each other as they are oriented from a front opening to the rear opening.

The speaker 72 is a low-pitched sound speaker. The opening of this speaker is an elongated ellipse, and the opening portion formed on the bottom of the chamber 62a has a profile elongated in the major axis direction of the ellipse.

Now, the unit substrate 61, the chamber 62a, the guide portion 62b that extends the opening portion 61h, and the sound emitting unit 21R may be an integral component. In addition, the unit substrate 61, the chamber 62a, and the guide portion 62b which extends the opening portion 61h may be an integral component and the sound emitting unit 21R may be formed in the cabinet.

FIG. 11B shows a case in which the above-described guide portion 62b and sound emitting unit 21R are temporarily removed. By doing this, pressure can be increased at the vestibule of the speaker 27, but the increased acoustic output is released from the opening portion at a stroke. Then, the low sound discharged from the opening portion is dispersed and is unable to be discharged to the speaker front efficiently with directivity. Consequently, the low-sound acoustic effects are degraded.

FIG. 11C shows a case in which the above-mentioned chamber 62a and guide portion 62b are temporarily removed. By doing this, there is no place to increase pressure of the low-pitched sound components output from the speaker 27. In addition, the output unit of the speaker 27 is narrowed. Consequently, the low-pitched sound output of the speaker 27 is suppressed, and the acoustic effects are degraded.

As described above, it can be understood that the configuration of FIG. 11A is superior to the configurations of FIGS. 11B and 11C. In addition, at a contact portion between the front end of the guide portion 62a and the rear part opening portion of the sound emitting unit 21R, an elastic member is arranged to absorb vibrations and to prevent vibrating sounds from being discharged.

Needless to say, the above-mentioned chamber 62a, guide portion 62b, sound emitting unit 21R, and the like may be called cavities.

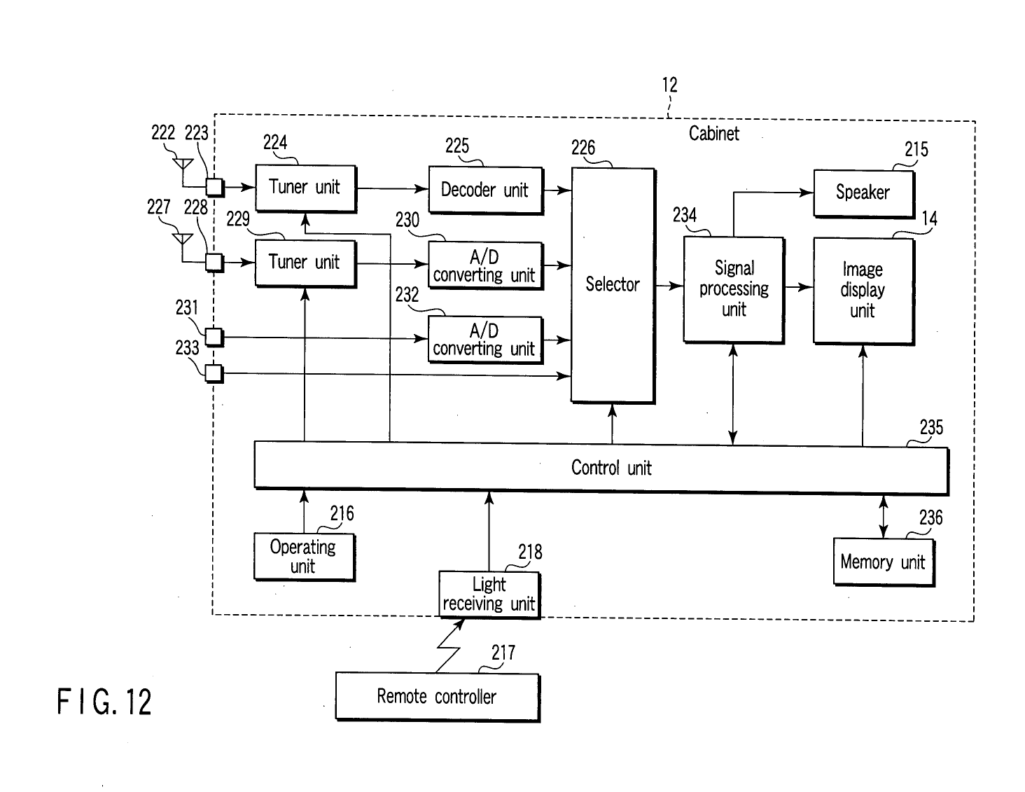

FIG. 12 schematically shows a signal processing system of the TV broadcast receiving apparatus (image display apparatus) 11. Various kinds of circuit blocks which configure the signal processing system are primarily located inside the cabinet 12 and at the position close to the back face thereof, that is, in the vicinity of the rear side of the display screen 14a of the image display unit 14.

Digital TV broadcast signals received by an antenna 222 for receiving digital TV broadcast are supplied to a tuner unit 224 via an input terminal 223. The tuner unit 224 selects and demodulates signals of a desired channel from the input digital TV broadcast signals. Then, the signals output from the tuner unit 224 are supplied to a decoder unit 225, subjected to, for example, Moving Picture Experts Group (MPEG) 2-decode processing, and then supplied to a selector 226.

Further, analog TV broadcast signals received by the antenna 227 for receiving analog TV broadcast are supplied to a tuner unit 229 via an input terminal 228. The tuner unit 229 selects and demodulates signals of a desired channel from the input analog TV broadcast signals. Then, the signals output from the tuner unit 229 are output to the selector 226 after being digitized at an analog-to-digital (A/D) converting unit 230.

In addition, analog video and audio signals supplied to an input terminal 231 for analog signals are supplied to an A/D converting unit 232 to be digitized, and then are output to the selector 226. Furthermore, digital video and audio signals supplied to an input terminal 233 for digital signals are supplied to the selector 226 as they are.

The selector 226 selects one of four kinds of input digital video and audio signals and supplies the selected signal to a signal processing unit 234. The signal processing unit 234 provides a predetermined signal processing to the input digital video signal to submit them for image display at the image display unit 14. For the image display unit 14, for example, a flash panel display comprising a liquid crystal display, a plasma display, etc., is adopted. In addition, the signal processing unit 234 provides a predetermined signal processing to the input digital audio signal, converts it into an analog signal, and outputs the analog signal to the speaker 215 (corresponds to the above-mentioned speaker devices 60R and 60L) to reproduce sound.

Now, the TV broadcast receiving apparatus 11 has various operations including various kinds of receiving operations described above overall controlled by a control unit 235. The control unit 235 is a microprocessor incorporating a central processing unit (CPU) and the like. Upon receipt of operation information from an operating unit 216 and an operator 221 (not shown) or operation information transmitted from a remote controller 17 via a light receiving unit 218, the control unit 235 controls the units, respectively, in such a manner as to reflect the operation content.

In this case, the control unit 235 uses a memory unit 236. The memory unit 236 is primarily equipped with a read only memory (ROM) which stores control programs executed by its CPU, a random access memory (RAM) for providing work areas to the CPU, and a nonvolatile memory in which various kinds of setting information, control information, and the like are stored.

By the above-mentioned means, it becomes easier to obtain designs that make the speaker mounting region look smaller as viewed from the front side of the cabinet. It is possible to obtain a speaker device for which contrivance is made to prevent speaker acoustic effects from being impaired along with improvement that, particularly, the speaker mounting region is made to look smaller as viewed from the front side, and its acoustic output unit configuration method and acoustic output method as well as an image display apparatus.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A speaker device comprising:
a speaker;
a unit substrate to one face of which the circumference of a front opening of the speaker is mounted;
a first cavity portion which is formed on the unit substrate and formed by extending the opening of the speaker spatially to the other face side of the unit substrate;
an opening portion which communicates with the first cavity portion and which is formed in an area smaller than the opening area of the first cavity portion;
a second cavity portion formed protrudably as if it extends the opening to the other face side of the unit substrate; and
a third cavity portion in which a reduced rear opening is bonded to a front end opening of the second cavity portion and cross-sectional profiles of first and second faces that continuously extend from the rear opening form a horn shape while being bent to depart away from each other as they are oriented from the rear opening to the front opening.

2. The speaker device according to claim 1, wherein the speaker is a low-range speaker.

3. The speaker device according to claim 1, wherein the speaker is a low-pitched sound speaker, the opening of the speaker is an elongated ellipse, and the opening of the first cavity portion has a slender profile in the major axis direction of the ellipse.

4. The speaker device according to claim 1, wherein the unit substrate, the first cavity portion, the second cavity portion which extends the opening portion, and the third cavity portion are configured as an integral component.

5. The speaker device according to claim 1, wherein the unit substrate, the first cavity portion, and the second cavity which extends the opening portion are configured as an integral component, and the third cavity portion is formed in a cabinet.

6. An image display apparatus with an image display unit and a speaker device mounted to a cabinet, comprising:
a front frame forming the cabinet, on which a display screen of the image display unit is arranged to be exposed from an opening at the center thereof;
a frame forming portion which forms a part of the front frame and is positioned at the lower part of the front frame;
a front opening portion formed slenderly in the frame forming portion in the lateral direction;
a speaker arranged on the rear side of the opening portion;
a first cavity portion formed by extending an opening of the speaker;
a second cavity portion which communicates with the first cavity portion and which has a volume smaller than that of the first cavity portion; and
a third cavity portion which communicates with the second cavity portion and which has a horn shape in which a front head end side gradually expands from the second cavity portion side and is connected to the front opening portion of the frame forming portion.

7. The image display apparatus according to claim 6, wherein the first and second cavity portions are configured by molding unit substrates to which the speaker is mounted, and the third cavity portion is formed in the frame forming portion.

8. The image display apparatus according to claim 7, further comprising:
mounting portions which are formed symmetrically with respect to a point with center at a central position of a rectangular unit substrate at respective places in the width direction at both ends in the longitudinal direction;
an opening portion opened in the unit substrate in the longitudinal direction of the unit substrate;
a high-range speaker mounted oppositely to the opening portion at an intermediate position on one face of the unit substrate in the longitudinal direction;
first and second low-range speakers mounted oppositely to the opening portion at respective positions on both sides of the high-range speaker; and
mounting portions installed to the unit substrate.

9. The image display apparatus according to claim 7, wherein the high-range speaker is arranged with the center thereof aligned to the central position and fixed by first and second fixing portions at positions which are symmetrical in the direction inclined with the central position set as the center, and
the low-range speakers are arranged at positions which are symmetric right and left with respect to the central position.

10. An acoustic output method of a speaker device comprises:
a speaker;
a first cavity portion formed by extending a front opening of the speaker;
a second cavity portion which communicates with the first cavity portion spatially and which has a volume smaller than that of the first cavity portion; and
a third cavity portion which communicates with the second cavity portion spatially and which is of a horn shape with a front end side gradually expanded from the second cavity portion side,
wherein an acoustic output from the speaker is compressed at the first cavity portion, converted into speed at the second cavity portion, and released from the third cavity portion.
